(19) United States
(12) Patent Application Publication
(10) Pub. No.: US 2013/0239827 A1
(43) Pub. Date: Sep. 19, 2013

(54) SYSTEM AND APPARATUS FOR MOUNTING HYDRAULIC CYLINDER TO PACKER PANEL OF REFUSE TRUCK

(71) Applicants: Arthur Baird Zimmerman, Huntsville, AL (US); Jeffrey Louis Liebner, Guntersville, AL (US); Dale Evan Wright, Arab, AL (US); Andrew Rolph Graves, Vinemont, AL (US)

(72) Inventors: Arthur Baird Zimmerman, Huntsville, AL (US); Jeffrey Louis Liebner, Guntersville, AL (US); Dale Evan Wright, Arab, AL (US); Andrew Rolph Graves, Vinemont, AL (US)

(21) Appl. No.: 13/421,213

(22) Filed: Mar. 15, 2012

(51) Int. Cl. B30B 5/00; B60P 1/04; B65F 3/28; B65G 65/40; B65G 67/26; B60P 1/00; B65F 3/20

(52) U.S. Cl. 100/240; 414/517; 414/469; 414/325

(57) ABSTRACT

A refuse truck has a container for receiving refuse, and a packer panel for compacting refuse. The forces for compacting refuse are provided by hydraulic cylinders. The hydraulic cylinders extend through and are coupled to the packer panel. The hydraulic cylinders are telescopic or rod cylinders that have an open length several times their closed length. The hydraulic cylinders provide bi-directional forces so that the packer panel can be pushed away from or pulled towards the front wall of the container.

### FIELD OF THE DISCLOSURE

The present disclosure generally relates to compacting systems of refuse trucks that have hydraulic cylinders for applying compacting forces. A container of the refuse truck receives refuse from multiple refuse bins and the collected refuse is stored in the container. The refuse is compacted by a packer panel that is pushed by forces of the hydraulic cylinders. When the hydraulic cylinders are activated by an equipment operator, the hydraulic cylinders apply forces that push the packer panel towards the rear of the closed container and compact the refuse. The hydraulic cylinders also apply forces that pull the packer panel back to a retracted position. A space between the packer panel and the rear of the container holds refuse, and equipment for operating the panel resides in a space between a front wall of the container and the packer panel. It is desirable to minimize the equipment space so that the refuse space can be maximized.

### BACKGROUND

In order to increase the volume of refuse a container of a refuse truck contains, a packer panel is provided to compact the refuse within the container. Hydraulic cylinders are frequently used to apply forces for pushing the packer panel for compacting refuse. The hydraulic cylinders are attached on one end to a front wall of the container and on the other end to a wall of the packer panel. When the attached hydraulic cylinders are closed (positioned at their shortest length), the packer panel is in a retracted position and the space in which the cylinders reside is at a minimum. When an operator activates the hydraulic cylinders for compacting refuse, the packer panel is pushed by hydraulic forces towards the rear of the container. During such an operation, the length of each hydraulic cylinder increases until it reaches a functional limitation or it lacks sufficient force to move the packer panel. The hydraulic cylinders for refuse trucks provide bi-directional forces, so that a packer panel may be pulled towards the front wall of the container or pushed towards the rear of the container. For some refuse trucks, the hydraulic cylinders also apply forces for unloading refuse from the container by pushing refuse out of the container when a rear door is opened.

Because container lengths are relatively long (e.g., 30 feet or more), telescopic hydraulic cylinders are often used, and such cylinders often have an open length equal to approximately five or more times their closed length. Further, a telescopic hydraulic cylinder typically has soft metal sleeves that are sometimes damaged when refuse inadvertently falls on the sleeves. There have been successful efforts to reduce sleeve damage by making the sleeves out of thicker and harder materials. However, such sleeve improvements have an increased cost.

A technique for reducing the size of the equipment space between the front wall of the container and the packer panel is to position the hydraulic cylinders in a crisscross arrangement or a cross over orientation. In this regard, a first hydraulic cylinder extends from the front wall near a front corner to an opposite side of the packer panel. Another hydraulic cylinder is elevated above the first hydraulic cylinder and extends from the front wall near the other front corner to the other side of the packer panel. The hydraulic cylinders form an “X” shape when viewed from above.

Although the hydraulic cylinders provide sufficient forces for operating the packer panel, they are relatively expensive and heavy. Further, the front wall of the container should be designed to withstand the forces generated by the cylinders. Decreasing the overall weight of the refuse truck via weight reductions in the container or the packer panel system without significant reductions in the size of the container is generally desirable so that fuel costs can be reduced. In addition, rotational bushings are usually needed to couple the hydraulic cylinders to the front wall and to the packer panel. Such bushings are complex, expensive and require a lubrication system.

Thus, a heretofore unaddressed need in the art for refuse truck designs that increase refuse storage space and/or reduce weight and costs without impairing a truck's ability to collect and deliver refuse.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts a conventional refuse truck having a packer panel and crisscross hydraulic cylinders for compacting and unloading refuse.

FIG. 2 depicts a top view of the conventional refuse truck depicted by FIG. 1.

FIG. 3 depicts an exemplary embodiment of a refuse truck of the present disclosure.

FIG. 4 depicts a partial top view of the embodiment of FIG. 3.

FIG. 5 depicts an exemplary embodiment of a compacting apparatus of the present disclosure with a packer panel in a retracted position.

FIG. 6 depicts a cross section view of the apparatus of FIG. 5.

FIG. 7 depicts an exemplary embodiment of a compacting apparatus of the present disclosure with a packer panel in a compacting position.

FIG. 8 depicts a cross section view of the apparatus of FIG. 7.

FIG. 9 depicts an exemplary embodiment of a compacting apparatus of the present disclosure with a packer panel in an unloading position.

FIG. 10 depicts a cross section view of the apparatus of FIG. 9.

FIG. 11 depicts an exemplary embodiment of a compacting apparatus of the present disclosure with a packer panel in a retracted position.

FIG. 12 depicts a cross section view of the apparatus of FIG. 11.

FIG. 13 depicts an exemplary embodiment of a compacting apparatus of the present disclosure with a packer panel in a compacting position.

FIG. 14 depicts a cross section view of the compacting apparatus of FIG. 13 when the truck frame rotates for unloading refuse.

FIG. 15 depicts a top view of a conventional hydraulic cylinder.

FIG. 16 depicts a front view of the conventional hydraulic cylinder of FIG. 15.

FIG. 17 depicts a top view of an extended conventional hydraulic cylinder.

FIG. 18 depicts a top view of a conventional telescopic hydraulic cylinder.

FIG. 19 depicts a front view of the cylinder of FIG. 18.

FIG. 20 depicts a top view of the cylinder of FIG. 17 in an extended condition.

FIG. 21 depicts an exemplary embodiment of a trunnion bracket.

FIG. 22 depicts an exemplary embodiment of a mounting ring.

### DETAILED DESCRIPTION

When a refuse-collection vehicle, such as a refuse truck, collects refuse, it usually has an automatic loading mechanism, a refuse container for storing the refuse, a packer panel, and hydraulic cylinders that apply bi-directional forces to the packer panel. Typically, the automatic loading mechanism grasps and moves a refuse bin, such as a residential trash can, to an opening near the top of the container of the refuse truck. The loading mechanism positions the refuse bin so that refuse falls from the refuse bin into the container. When an operator activates the hydraulic cylinders for compacting refuse, the hydraulic cylinders apply forces to the packer panel so that the refuse is compacted between a closed rear door and the packer panel. The amount of space for storing compacted refuse within the container is limited by the size of the container and by the size of an equipment compartment of the container, i.e., the space required for the hydraulic cylinders and other equipment. It is desirable that the equipment compartment of the container be as small possible so that the space for storing refuse is as large as possible.

When compared to conventional refuse compacting systems, an embodiment of a compacting system of the present disclosure reduces or at the best does not require an increase in the size of the equipment compartment a container of a refuse truck. In such embodiment, the compacting system comprises hydraulic cylinders, and each cylinder has a barrel that passes though a packer panel. It is possible for a portion of the barrel to be located within the refuse space of the container and another portion of the barrel to be located within the equipment space of the container. The midsection of each barrel is coupled to the packer panel and a rod end of each hydraulic cylinder is coupled to a front wall of the container. In such an arrangement, the cylinders may extend in a direction substantially parallel to the direction of motion of the packer panel such that a greater percentage of the force generated by the hydraulic cylinders is applied in the direction of motion relative to embodiments in which the cylinders are crisscrossed. Thus, smaller cylinders can be used to generate a sufficient force, thereby reducing the cost and weight of the cylinders without requiring an increase to the equipment space. In fact, it is possible for the size of the equipment space to be reduced, such that the refuse space can be increased for a given container size. In addition, the embodiment of the compacting system has the hydraulic cylinders positioned along the sides of the container so that the chance of sleeve damage to a telescopic cylinder is reduced.

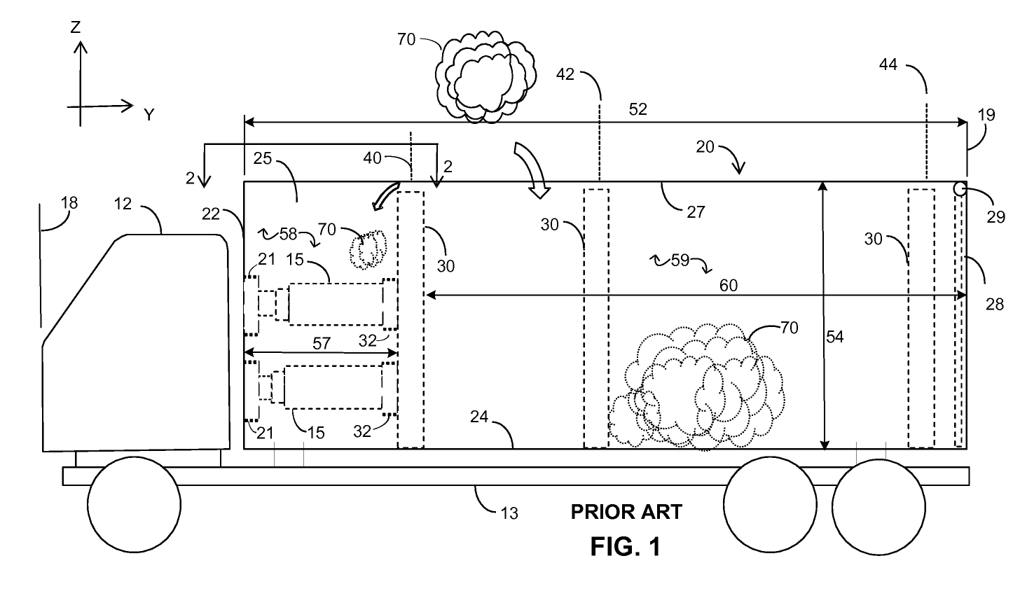

FIG. 1 depicts a conventional refuse truck with hydraulic cylinders 15. The container 20 is located behind a cab 12 of the refuse truck and mounted on a frame 13. The front 18 of the cab 12 is the front of the truck. The cab 12 has an interior with positions for a vehicle driver and/or an equipment operator. The vehicle frame 13 and container 20 extend longitudinally (the y-direction) from the cab 12 towards a rear 19 of the truck. The container 20 has a front wall 22, two side walls 25, a floor 24, a ceiling 27, and a rear door 28. The rear door 28 is securely closed when the refuse truck collects refuse and is opened when refuse is unloaded from the container 20. An opening (not shown) in the ceiling 27 forms an entry port for refuse 70 that drops through the opening when a refuse loading device positions a refuse bin above the opening.

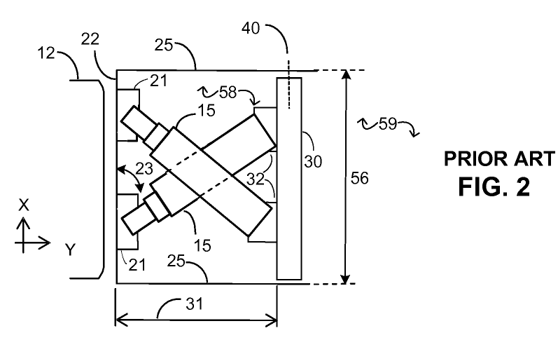

The container 20 has a refuse compartment 59, for containing refuse, and an equipment compartment 58, for containing equipment (e.g., cylinders 15). It is usually desirable to have a small equipment compartment 58 so that the refuse compartment 59 can be larger. The approximate volume of the container 20 is defined by multiplying the container's length 52, height 54 and width 56 (FIG. 2). Typically, a refuse-truck container has a volume of approximately 20 cubic yards. The volume of the refuse compartment 59 depends on its length 60 (measured in the y-direction) that is defined as the distance from a packer panel 30 in a retracted location 40 to the rear door 28. A width (measured in the x-direction) of the refuse compartment is approximately the width 56 of the container and a height (measured in the z-direction) of the refuse compartment is approximately the height 54 of the container 20. The equipment compartment 58 has a length 57 (measured in the y-direction) defined as a distance between the front wall 22 of the container 20 and the packer panel 30 when the packer panel is in a retracted location 40. A width (measured in the x-direction) of the equipment compartment 58 is approximately the width 56 of the container and a height (measured in the z-direction) of the equipment compartment 58 is approximately the height 54 of the container.

A conventional technique to reduce the size of the equipment compartment includes positioning hydraulic cylinders 15 in a crisscross arrangement as depicted in FIG. 1 and FIG. 2. The crisscross arrangement can reduce the distance between the front wall 22 and the packer panel 30 in a retracted location 40 by approximately 30% or more when compared to a non-crisscross arrangement of hydraulic cylinders. A rod end of the hydraulic cylinders 15 is coupled to the front wall 22 by a mount 21 at a coupling angle 23. For the crisscross arrangement, a smaller coupling angle 23 provides a smaller equipment compartment 58. However, as the coupling angle 23 decreases, the rearward (the y-direction) vector force of the hydraulic cylinders 15 are diminished. Hence, if the coupling angle 23 is too small, such as 30 degrees or smaller, then it is difficult for the hydraulic cylinders 15 to apply sufficient force to move the packer panel 30 from a retracted location 40 towards (the y-direction) the back of the refuse truck. As depicted in FIG. 1 and FIG. 2, each of the hydraulic cylinders 15 has a rod end coupled to the front wall 22 with a mount 21 and a barrel end of each of the hydraulic cylinders 15 coupled to packer panel 30 with another mount 32. The mounts 21 and 32 utilize spherical bushings because of a range of angular motion required of the hydraulic cylinders 15 as the packer panel 30 moves to and from a variety of operational locations. Such spherical bushings are expensive and require a lubrication system to prevent the bushing from wearing out.

In order to understand the operation of the conventional refuse truck, assume that the refuse truck is empty, i.e., there is no refuse in the container, and the truck is in the process of collecting refuse. When the refuse truck begins the refuse collection process, the packer panel 30 is in the retracted location 40 as depicted in FIG. 1. At each refuse pickup location, the container 20 receives refuse 70 through an opening in the top of the container 20 when the operator of an automatic loader (not shown) positions a trash can above the opening. As more and more refuse drops into the container 20, the operator may determine it is desirable to compact refuse 70. If so, the operator then activates the hydraulic cylinders 15 so that forces are applied to the packer panel 30. The packer panel 30 moves towards the end 19 of the container (the y-direction) to a packing position 42. The distance the packer panel 30 is able to travel for compacting refuse depends on the amount of refuse within the container 20. When the refuse compartment 59 of the container is no longer capable of accepting refuse, i.e., the container is full, then the refuse truck goes to an unloading site, such as a land fill.

The unloading action begins when the refuse truck is at the unloading site. The rear door 28 is opened, for example, by rotating the door 28 about a hinge 29. The operator then activates the hydraulic cylinders 15 for unloading refuse. Forces applied by the hydraulic cylinders 15 push the packer panel 30 from its retracted location 40 towards (the y-direction) the opening at the rear 19 of the refuse truck. As the packer panel 30 moves, refuse 70 is pushed out of the opening at the back of the container 20. When the hydraulic cylinders 15 are fully extended the packer panel 30 is in the unloading position 44 and unloading is complete.

The conventional system as depicted in FIG. 1 and FIG. 2 reduces the size of the equipment compartment 58 of the container 20. However, as indicated earlier, the conventional system increases the weight and cost of the refuse truck because it requires larger hydraulic cylinders. The term “hydraulic cylinder” includes both telescopic hydraulic cylinders that have sleeves and hydraulic cylinders with no sleeves. For refuse trucks that have telescopic hydraulic cylinders, sleeves of the hydraulic cylinders may be damaged if refuse inadvertently falls on the sleeves. For example, if refuse contains heavy metallic objects, such objects may fall on and damage the sleeves. If the telescopic hydraulic cylinder is not capable of functioning due to damages, it is then necessary to replace or repair the cylinders. The crisscross arrangement is particularly vulnerable to refuse damage since a portion of a sleeve is always located along the centerline of the container 20. Although the conventional compacting system having the crisscross arrangement of hydraulic cylinders has shortcomings, the system does reduce the size of the equipment

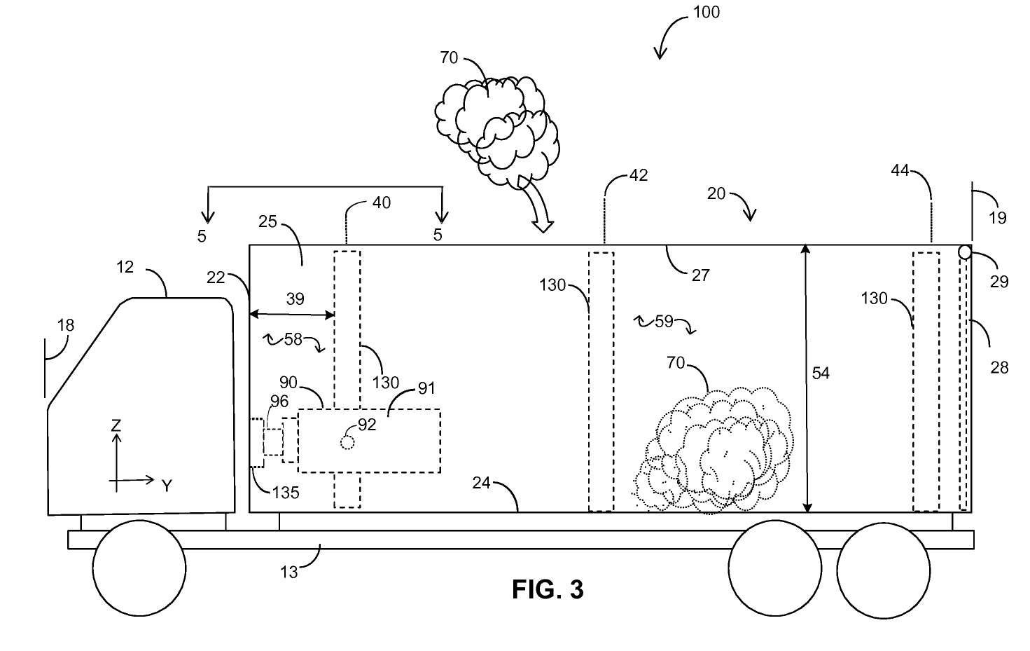

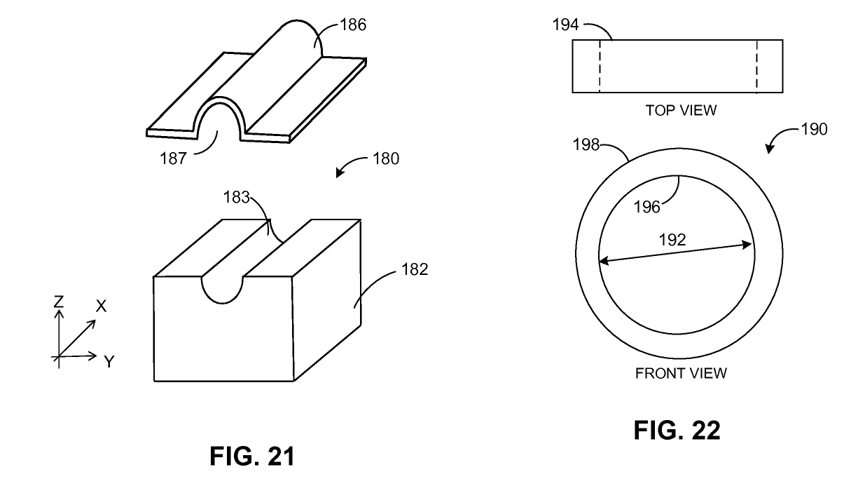

FIG. 3 depicts an embodiment of a compacting system 100 of the present disclosure. The compacting system 100, comprising two hydraulic cylinders 90 and a packer panel 130, compacts refuse within container 20 of a refuse truck. The hydraulic cylinders 90 are activated by an operator and provide forces for pushing and pulling the packer panel 130. Each hydraulic cylinder 90 has a barrel 91 and a rod 96. The barrel 91 of each hydraulic cylinder 90 passes through an aperture in the packer panel 130 and is trunnion coupled to the packer panel 130 via trunnion pins 92 and a trunnion bracket 180 (FIG. 21). The trunnion bracket 180 is attached to surfaces of the packer panel 130, such as surfaces of the packer panel 130 that form the aperture. Shielding plates 89 (only one is shown) fit around the barrel 91 and are attached, via screws or other fasteners, to the packer panel 130. Each shielding plate 89 is generally flat with a round aperture dimensioned so that the shielding plate 89 fits around a respective one of the barrels 91. The shielding plates 89 prevent refuse, contained in the refuse compartment 59 of the container, from entering the equipment compartment 58 of the container 20 through the aperture in the packer panel through which the barrel 91 passes. When the barrel 91 is coupled to the packer panel 130 movement of the barrel 91 results in a corresponding movement of the packer panel 130. In general, the barrel 91 of a hydraulic cylinder is made of high strength materials so that falling refuse does not usually damage the barrel. For some embodiments of the compacting system 100, the barrel is modified so that it can better withstand the impact of refuse entering the container via the loading system. The modifications may include, for example, using stronger materials, thicker materials, or covering the top side of the barrel with a barrel shield mounted on the packer panel 130. The rod 96 of the hydraulic cylinder 90 is coupled to the front wall 22 of container 20 via conventional couplers.

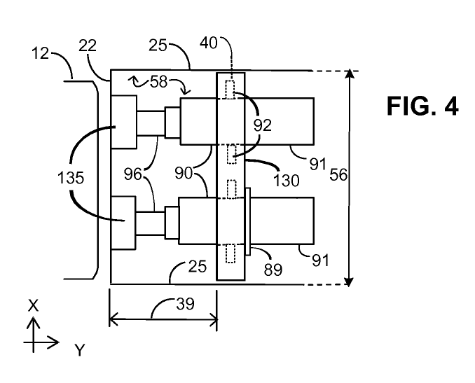

As previously indicated, it is generally desirable that the refuse compartment 59 of the container 20 be as large as possible and that the equipment compartment 58 of the container 20 be as small as possible. The compacting system 100 of FIG. 3 and FIG. 4 has such a characteristic. Further, when the hydraulic cylinders 90 are telescopic hydraulic cylinders, such as a five stage hydraulic cylinder, the equipment compartment 58 of the container 20 may be around 10% of the total volume of the container 20. In other embodiments having other hydraulic cylinders, such as a single-stage hydraulic cylinder, the size of the equipment compartment 58 of the container is also reduced when the barrel 91 passes through the packer panel 130.

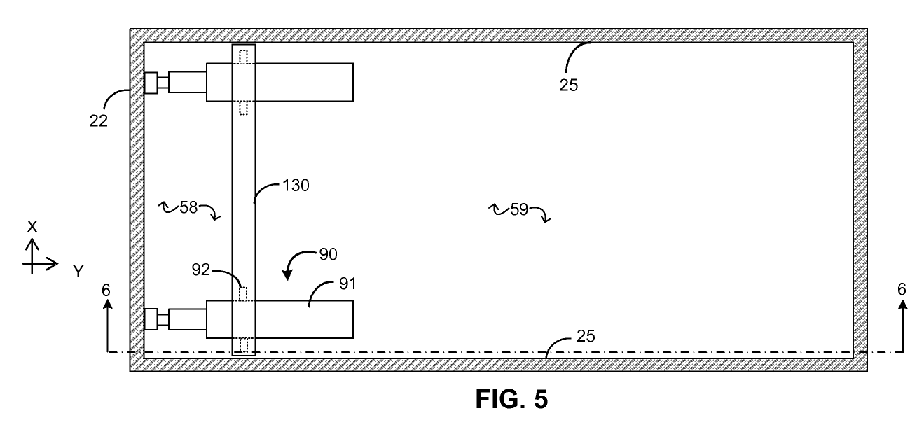

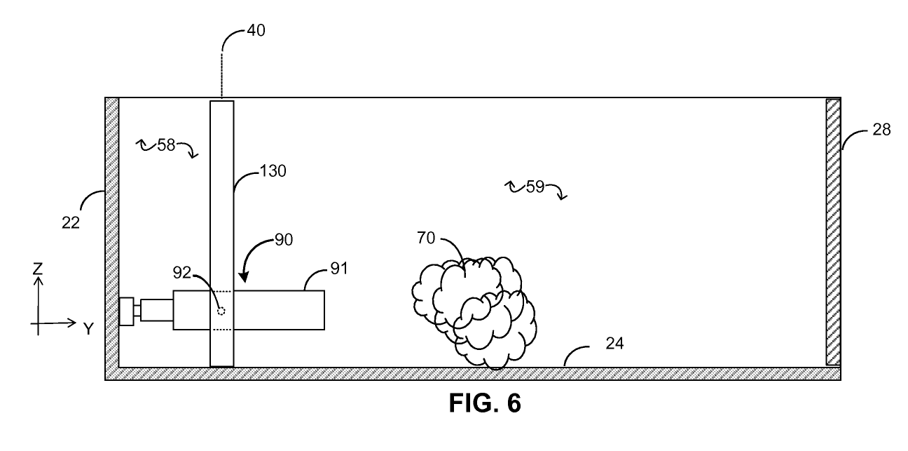

FIG. 5 and FIG. 6 depict the system of FIG. 3 when the packer panel 130 is in a retracted position at retracted location 40. When the container receives refuse 70, the packer panel 130 remains in the retracted position until the operator activates the hydraulic cylinders 90 to compact the refuse 70. The forces provided by the hydraulic cylinders 90 are, for the most part, longitudinal (in the y-direction) forces and do not have any sideward (the x-direction) or vertical (the z-direction) force components. Thus, most if not all of the force applied by the cylinders is in the direction of movement of the packer panel. Accordingly, less force is needed than would be required if the forces were applied in other directions. Thus, cylinders of smaller size, weight, and cost can be used.

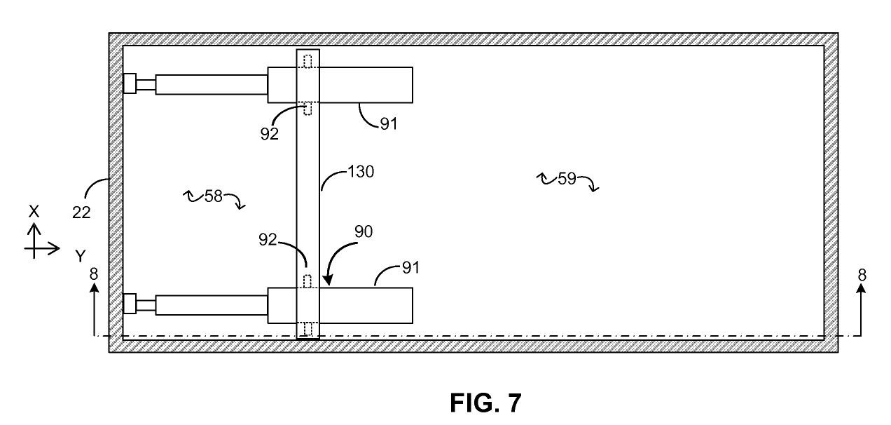

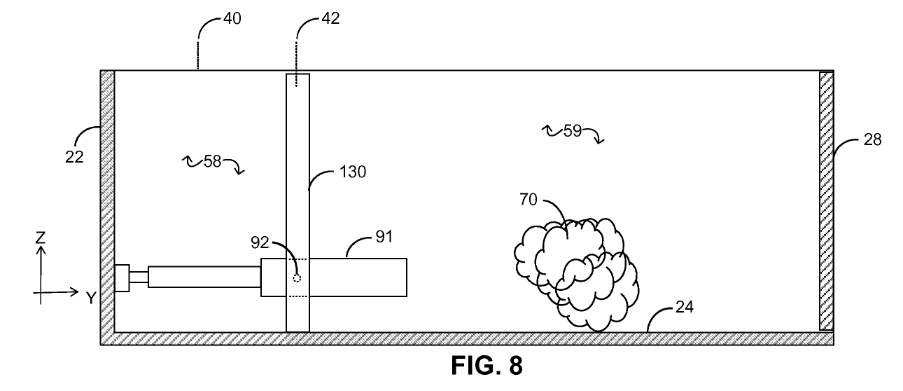

FIG. 7 and FIG. 8 depict the system of FIG. 3 when the packer panel 130 is in a compacting position at compacting location 42. The compacting location 42 is dependent on the amount and type of refuse within the refuse compartment 59 of the container 20 and on the amount of force applied by the hydraulic cylinders. The compacting action occurs continuously, initiated by the operator, until the refuse compartment 59 of the container is full, i.e., it can accept no more refuse. When the refuse compartment 59 of the container is full, the refuse truck travels to an unloading site, such as a land fill, and unloads the compacted refuse.

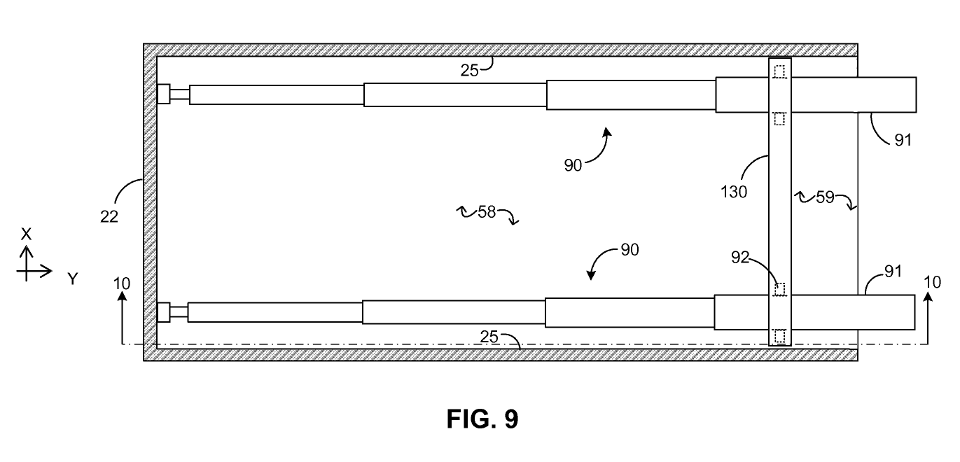

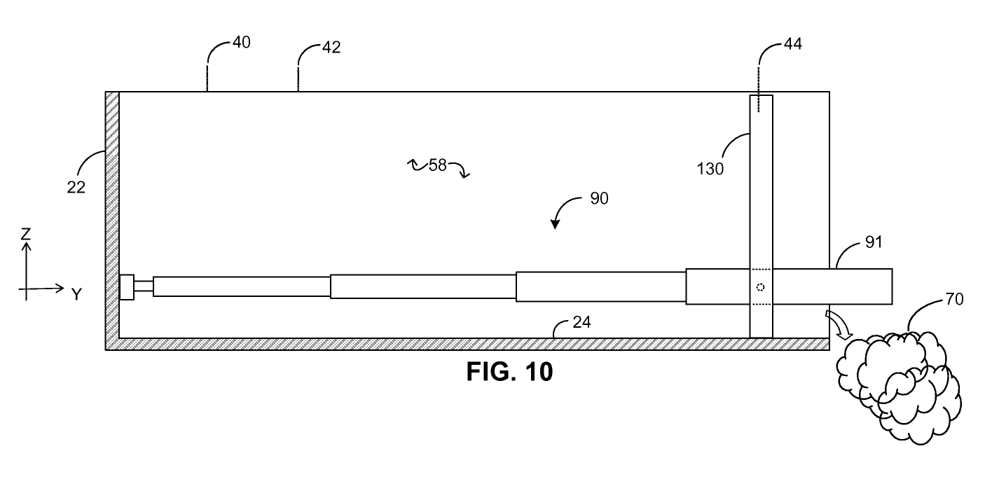

FIG. 9 and FIG. 10 depict the system of FIG. 3 when the packer panel 130 has transitioned to an unloading location 44. Before the packer panel is activated to move to unloading location the rear of the container is opened and the truck is located where compacted refuse will fall at a selected location. The packer panel 130 is pushed from the retracted location 40 to the unloading position by forces of the hydraulic cylinders 90. When the packer panel reaches the unloading location 44, the hydraulic cylinders 90 are fully extended. The length of a 6 stage telescopic hydraulic cylinder, such as a Hyco Model 20185-916-440, has a closed length of approximately 8 feet and a fully extended length of approximately 45 feet. If one half of the length of the barrel of the hydraulic cylinder, 4 feet, is located within the equipment compartment 58 of the container, then the refuse compartment 59 of the container 20 is approximately 40 feet long. The above example indicates that compacting system 100 can provides an equipment compartment that is less than 10% of the container's volume.

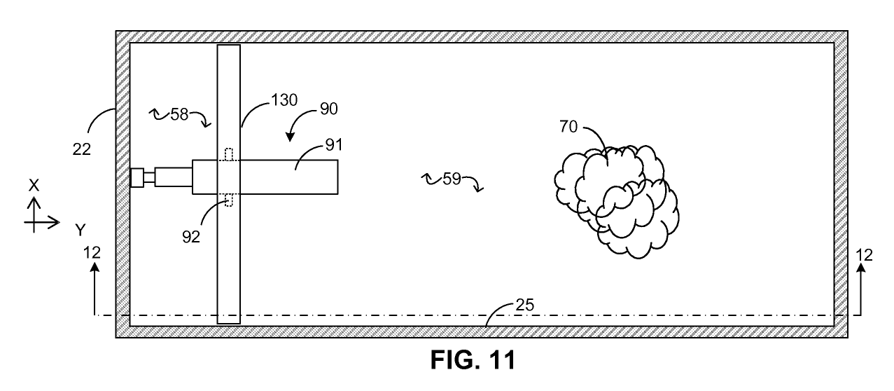

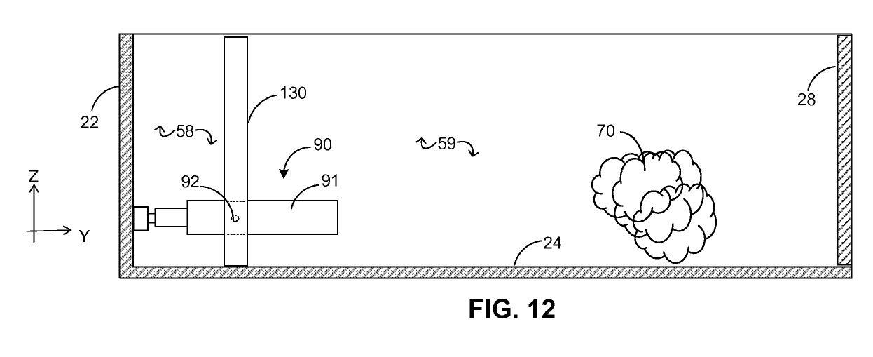

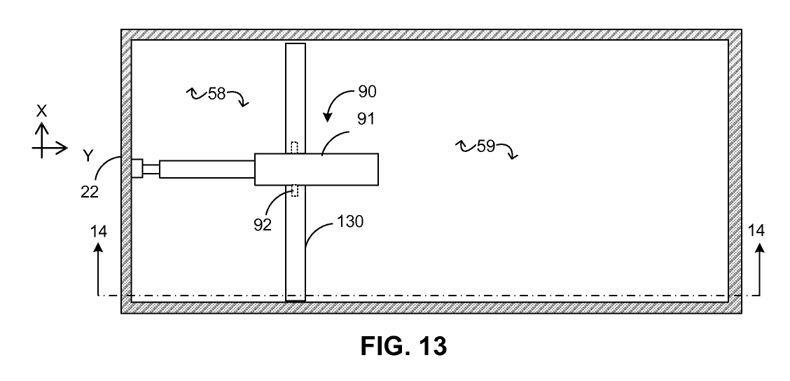

FIG. 11 and FIG. 12 depict an embodiment of a compacting system wherein the packer panel 130 is coupled to a single one-plunger hydraulic cylinder 90. In other embodiments other numbers of plungers may be used. The barrel 91 of the hydraulic cylinder 90 passes through and is trunnion coupled to packer panel 130. FIG. 12 depicts the packer panel 130 in a retracted location 40. Upon a command from the operator, hydraulic cylinders 90 apply forces that push the packer panel 130 towards (the y-direction) end of the refuse truck. If each hydraulic cylinder is a single stage cylinder, then the hydraulic cylinder is fully extended when it reaches location compacting location 42. FIG. 13 and FIG. 14 depict another apparatus for unloading refuse. When the operator determines the refuse truck is full or otherwise needs to be unloaded, then the refuse truck travels to a land fill. Upon positioning the refuse truck for unloading, an unloading hydraulic cylinder 160 rotates the front wall 22 of container 20 upward (the z-direction) until the container floor 24 has sufficient slope for the refuse to slide out of the container.

In other embodiments, it is possible to have more than two hydraulic cylinders for moving the packer panel 130 to locations within the container 20. Although the rod end 96 of the hydraulic cylinder 90 is pin and eye coupled to the front wall 22 in one embodiment, other coupling techniques are possible in other embodiments. Trunnion coupling the barrel 91 passing through the packer panel 130 is not a limitation on the present disclosure. In other embodiments, other barrel coupling techniques are possible. For example, the barrel 91 could be attached using collars, tabs, or other known attachment techniques.

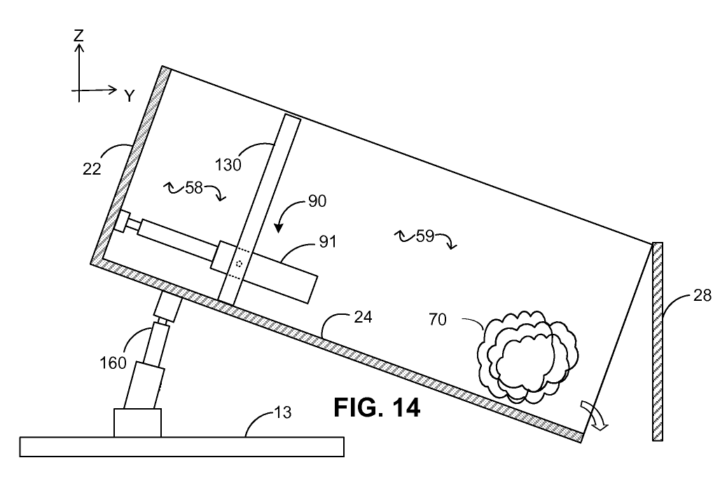

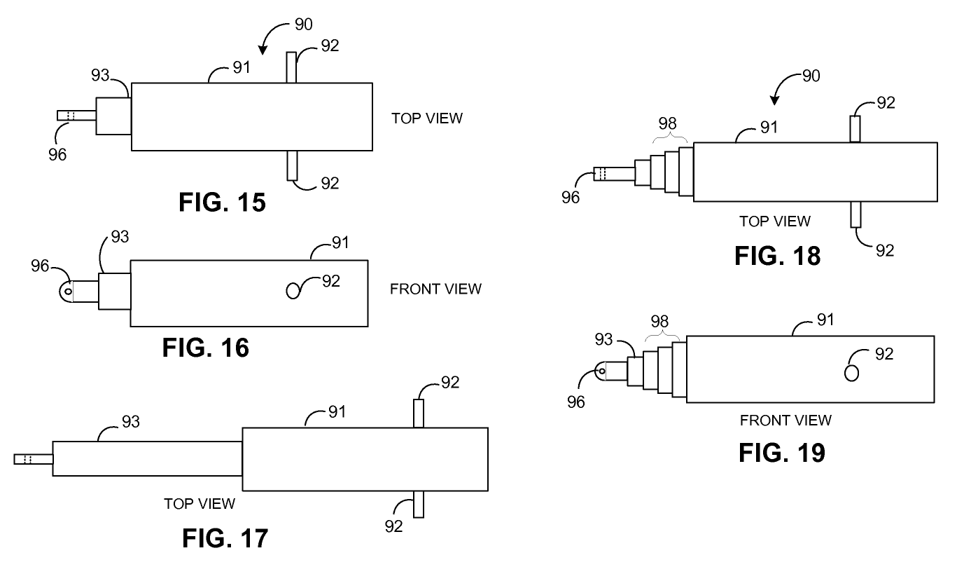

FIGS. 15, 16 and 17 depict several views of a one-plunger hydraulic cylinder 90. The hydraulic cylinder 90 depicted has a barrel 91 and trunnion pins 92 extending from the barrel. A rod 93 is shown on one end of the hydraulic cylinder 90 and has a tab with an eye 96 that extends from the rod 93. FIG. 15 shows the hydraulic cylinder 90 when it is closed. FIG. 17 shows it the hydraulic cylinder when it is fully opened.

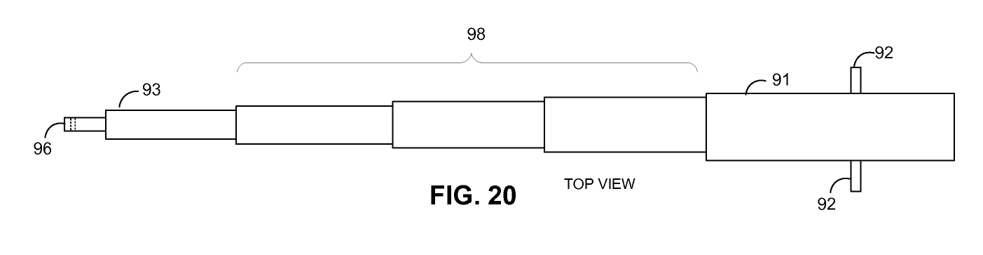

FIGS. 18, 19 and 20 depict several views of a telescopic hydraulic cylinder 90. The telescopic hydraulic cylinder 90 has a barrel 91 and trunnion pins 92 extending from the barrel. A rod 93 is shown on one end of the hydraulic cylinder 90 and has a tab with an eye 96 that extends from the rod 93. The telescopic hydraulic cylinder has sleeves 98 that allow the hydraulic cylinder to extend to several times its closed length. FIG. 18 and FIG. 19 shows the telescopic hydraulic cylinder 90 when it is closed. FIG. 20 shows it the telescopic hydraulic cylinder when it is fully opened.

FIG. 21 depicts an embodiment of a trunnion mount 180 for coupling the barrel 91 of the hydraulic cylinder 90 within an aperture in the packer panel 130. A base 182 of trunnion mount 180 has a circular groove 183 slightly larger than the diameter of the trunnion pins 92. A back surface (parallel to the z-y plane) of the base 182 is attached to a vertical surface forming the aperture in the packer panel 130. Another base 182 is attached to another vertical surface of the aperture. The distance between the attached bases 182 is such that the barrel 91 fits between the bases 182 and allows the trunnion pins to drop into the circular grooves 183. A trunnion cap 186 having a circular slot 187 is attached to each of the bases 183 to secure the barrel 91 to the packer panel 130.

A collar 190 for coupling the barrel of the packer panel is depicted in FIG. 22. The collar has a circular shape with a circular aperture. The circular aperture has a diameter 192 slightly greater than the diameter of the barrel 91. The collar 190 is positioned about the barrel by sliding the collar over the barrel. The collar 190 is then attached, such as by welding interior surfaces 196, to the barrel 91. The back surface 194 of the collar is then attached with conventional methods to the packer panel 130. In some embodiments two collars 190 are used on each barrel 91. The collars 190 also serves as a shield to prevent refuse within the refuse compartment 59 of the container from getting into the equipment compartment 58 of the container.

Although the disclosure is described in several embodiments, a variety of changes and modifications would be apparent to those skilled in the art without departing from the spirit and scope of the disclosure. Note, in particular, that the exemplary architectures described could also be used for other compression containers.

Now, therefore, the following is claimed:

1. A compacting system for refuse, comprising:
a container, the container having walls and a floor that define a cavity;
a packer panel for moving the refuse within the cavity; and
a hydraulic cylinder mounted to a wall of the container and extending through and coupled to the packer panel.

2. The compacting system of claim 1, wherein the hydraulic cylinder is a telescopic hydraulic cylinder.

3. The compacting system of claim 1, wherein the hydraulic cylinder is a rod hydraulic cylinder.

4. The compacting system of claim 2, wherein the barrel of the hydraulic cylinder has trunnion pins coupled to trunnion mounts of the packer panel.

5. The compacting system of claim 2, wherein the end of the hydraulic cylinder mounted to the wall is eye mounted.

6. The compacting system of claim 1, wherein the container is mounted to a frame of a truck.

7. The compacting system of claim 6, wherein the container has a door.

8. The compacting system of claim 7, wherein the packer panel pushes refuse out of the container when the door is opened.

9. The compacting system of claim 7, wherein a portion of the truck frame pivots for removal of refuse.

10. A refuse truck, comprising:
a container, mounted on a frame of the refuse truck;
a packer panel extending between side walls of the container; and
a hydraulic cylinder extending through the packer panel and mounted to the packer panel.

11. The refuse truck of claim 10, wherein the hydraulic cylinder has a barrel that is trunnion mounted to the packer panel.

12. The refuse truck of claim 10, wherein the hydraulic cylinder has a rod end that is mounted to a front wall of the container.

13. The refuse truck of claim 10, wherein the hydraulic cylinder is parallel to a side wall of the container.

14. The refuse truck of claim 13, wherein the hydraulic cylinder is parallel to a floor of the container.

15. An apparatus for compacting refuse, comprising:
a container, the container having walls and a floor that define a cavity;
a packer panel positioned within the cavity and defining a equipment portion and a refuse portion when the packer panel is in a retracted position; and;
a hydraulic cylinder that passes through the packer panel and is coupled to the packer panel.

16. The apparatus of claim 15, wherein the hydraulic cylinder has a barrel that is trunnion coupled to the packer panel.

17. The apparatus of claim 15, wherein the hydraulic cylinder is collar coupled to the packer panel.

18. The apparatus of claim 15, wherein the hydraulic cylinder has a rod end that is mounted to a front wall of the container.

19. The apparatus of claim 15, wherein the hydraulic cylinder is a telescopic hydraulic cylinder.

20. The apparatus of claim 15, wherein the container is unloaded by the hydraulic cylinders
